(19) United States
(12) Patent Application Publication
(10) Pub. No.: US 2016/0188251 A1
(43) Pub. Date: Jun. 30, 2016

(54) Techniques for Creating a Notion of Privileged Data Access in a Unified Virtual Memory System

(71) Applicant: Nvidia Corporation, Santa Clara, CA (US)

(72) Inventors: Lucien Dunning, San Jose, CA (US); Dwayne Swoboda, San Jose, CA (US); Arvind Gopalakrishnan, Redwood City, CA (US); Cameron Buschardt, Round Rock, TX (US)

(21) Appl. No.: 14/800,684

(22) Filed: Jul. 15, 2015

Related U.S. Application Data
(60) Provisional application No. 62/024,928, filed on Jul. 15, 2014.

(51) Int. Cl. G06F 3/06; G06F 12/10

(52) U.S. Cl. CPC G06F 3/0647; G06F 3/061; G06F 3/0683; G06F 12/1009; G06F 2212/1016

(57) ABSTRACT

Unified virtual memory (UVM) management techniques using page table sharing between user mode and kernel mode GPU address spaces and creating the notion of privileged level of data.

### CROSS-REFERENCE TO RELATED APPLICATIONS

This application claims the benefit of U.S. Provisional Patent Application No. 62/024,928, filed Jul. 14, 2015, which is incorporated herein in its entirety.

### BACKGROUND OF THE INVENTION

Computing systems have made significant contributions toward the advancement of modern society and are utilized in a number of applications to achieve advantageous results. Numerous devices, such as desktop personal, computers (PCs), laptop PCs, tablet PCs, netbooks, smart phones, servers, and the like have facilitated increased productivity and reduced costs in communicating and analyzing data in most areas of entertainment, education, business, and science. One common aspect of computing systems is the memory subsystems for the central processing unit (CPU) and graphics processing unit (GPU).

The various memories (e.g., computing device-readable media) store information utilized by the CPU and GPU in performance of a number of different tasks. Other components of a system typically request access to memory in order to retrieve (e.g., “read”) information from and store (e.g., “write”) information to the memory. Different types of memories (e.g., mass storage, main memory, removable memory and the like) and/or memory “spaces” (e.g., virtual, physical) can be utilized to support information storage.

Different types of computing device-readable media can potentially offer different features, such as storage capacity and access speed. Traditionally, memories that have relatively large storage capacity have relatively slow access speeds. Systems that have relatively fast access speeds, in contrast, typically have relatively small storage capacities. For example, primary memories (e.g., main memory) are relatively fast compared to secondary memories (e.g., mass storage memory) but typically store less information. In view of the tradeoffs, a number of systems transfer chunks of information, between relatively fast small memories and relatively slow bulk memories to attempt to optimize speed and capacity.

Another technique for optimizing performance in computing devices is to utilize virtual and physical address spaces. Virtual address space allows applications to utilize as much memory as needed without regard to the memory utilization of other applications. The application retrieves and stores instructions and data utilizing virtual addresses, and the memory system retrieves and stores instruction and data in physically memory using physical addresses to optimize performance. Accordingly, translation between the virtual memory space addressing and physical memory space addressing is performed by the computing system. As a result, applications and data may be moved within memory and between different types of memory. However, applications use the same virtual address regardless of the true physical address.

Referring to FIG. 1, an exemplary computing device 100 is illustrated. The computing device 100 may be a personal computer, server computer, client computer, laptop computer, tablet computer, smart phone, distributed computer system, or the like. The computing device 100 includes one or more central processing units (CPU) 110, one or more specialized processing units such as graphics processing units (GPU) 115, one or more computing device-readable media 120, 125, 130 and one or more input/output (I/O) devices 135, 140, 145, 150. The I/O device 135, 140, 145, 150 may include a network adapter (e.g., Ethernet card), CD drive, DVD drive and/or the like, and peripherals such as a keyboard, a pointing device, a speaker, a printer, and/or the like.

The computing device-readable media 120, 125, 130 may be characterized as primary memory and secondary memory. Generally, the secondary memory, such as a magnetic and/or optical storage, provides tor non-volatile storage of computer-readable instructions and data for use by the computing device 100. For instance, the disk drive 125 may store the operating system (OS) 155 and applications and data 160. The primary memory, such as the system memory 120 and/or graphics memory 130, provides for volatile storage of computer-readable instructions and data for use by the computing device 100. For instance, the system memory 120 may temporarily store a portion of the operating system 155′ and a portion of one or more applications and associated data 160′ that are currently used by the CPU 110, GPU 115, and the like.

The computing device-readable media 120, 125, 130, I/O devices 135, 140, 145, 150, and GPU 115 may be communicatively coupled to the processor 110 by a chip set 165 and one or more busses. The chipset 165 acts as a simple input/output hub for communicating data and instructions between the processor 110 and the computing device-readable media 120, 125, 130, I/O devices 135, 140, 145, 150, and GPU 115. In one implementation, the chipset 165 includes a northbridge 170 and southbridge 175. The northbridge 170 provides for communication with the processor 110 and interaction with the system memory 115. The southbridge 175 provides for input/output functions.

The GPU 115 may include a memory management unit (MMU) 180 for managing the transfer of data and instructions between the graphics memory 130 system memory 120. However, in other embodiments the MMU 180 may be an independent circuit, a part of the chip set 165, a part of the primary or secondary memory, and/or other element in the computing device. The northbridge 170 may also include an MMU 185 for managing the transfer of data and instructions between the system memory 120 and the disk drive 125 for the CPU 110. In other embodiments the MMU 185 may be an independent circuit, a part of the chip set 165, an integrated with the MMU 180 for the GPU in the chip set 165, a part of the primary or secondary memory, and/or other element in the computing device.

The MMUs 180, 185 translate virtual addresses to physical addresses using an address translation data structure. Referring now to FIG. 2, an exemplary address translation data structure utilized to translate virtual addresses 210 to physical addresses 220 is illustrated. The address translation data structure may include a page table data structure 230 and a translation lookaside buffer (TLB) 240. The page table data structure 230 may include a page directory (PD) 250 and one or more page tables (FT) 260-290. The page directory (PD) 250 includes a plurality of page directory entries (PDE). Each PDE includes the address of a corresponding page table (FT) 260-290. Each PDE may also include one or more parameters. Each page table (PT) 260-290 includes one or more page table entries (PTE). Each page table entry (PTE) includes a corresponding physical address of data and/or instructions in primary or secondary memory. Each page table entry (PTE) may also include one or more parameters.

Upon receiving a virtual address, the TLB 240 is accessed to determine if a mapping between the virtual address 210 and the physical address 220 has been cached. If a valid mapping has been cached (e.g., TLB hit), the physical address 220 is output from the TLB 240. If a valid mapping is not cached in the TLB 240, the page table data structure 230 is walked to translate the virtual address 210 to a physical address 220. More specifically, the virtual address 210 may include a page director index, a page table index, and a byte index. The page directory index in the virtual address 210 is used to index the page directory 250 to obtain the address of an appropriate page table 270. The page table index in the virtual address 210 is used to index the appropriate page table specified in the given PDE to obtain the physical address 220 of the page containing the data. The byte index in the virtual address 210 is then used to index the physical page to access the actual data. The resulting mapping is then typically cached in the TLB 240 for use in translating subsequent memory access requests. Furthermore, as a page moves from secondary memory to primary memory or from primary memory back to secondary memory, the corresponding PTE in the page table data structure 230 and TLB 240 is updated.

Generally, the memory space of the CPU is mapped separately from the memory space of the GPU. In such cases, the kernel mode of a single CPU thread deals with a corresponding single GPU. Data is transferred (e.g., direct memory access (DMA)) from system memory into GPU memory, the data is processed by the particular GPU and then transferred back from the GPU memory to system memory if applicable. However, there is a current trend toward unified virtual memory (UVM), wherein data is migrated when needed between the host memory and device memory and thereafter is available to both processors on their respective memories. For UVM, address space needs to be allocated on both memories for data that needs to be shared between CPU and GPU.

### SUMMARY OF THE INVENTION

The present technology may best be understood by referring to the following description and accompanying drawings that are used to illustrate embodiments of the present technology directed toward techniques for data migration in a unified virtual memory (UVM) system.

In one embodiment, a UVM memory management method includes creating page directory and page table mappings associated to a user mode page directory base when allocating user mode address space. When allocating migration channel address space, a chunk of available user mode address space is reserved. User mode allocation from the reserved chunk are disallowed. The allocation also includes creating page directory and page table mappings associated to a migration channel page directory base. For user mode address space changes, the method also makes page directory and/or page table updates associated to the user mode page director base. The updates made to user mode page directory are also replicated into the page directory associated to the migration channel page directory base. For migration channel address space changes, the method also makes page directory and/or page table updates associated to the migration channel page directory base. However, no changes are replicated into the corresponding reserved chunk of the user mode page directory associated to the user mode page director base.

Accordingly, the user mode and kernel migration channels can use the same unified pointer to move data, without separate tracking/translation. Privileged kernel allocations are achieved by reserving a chunk of the net address space available to tire user mode. The memory allocator will ensure that the user will not be able to allocate out of this region and kernel allocations are restricted to only this region. The fact that one can have separate page directory bases' ensures that user mode accesses to the privileged region will cause the GPU to fault.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an exemplary computing device.

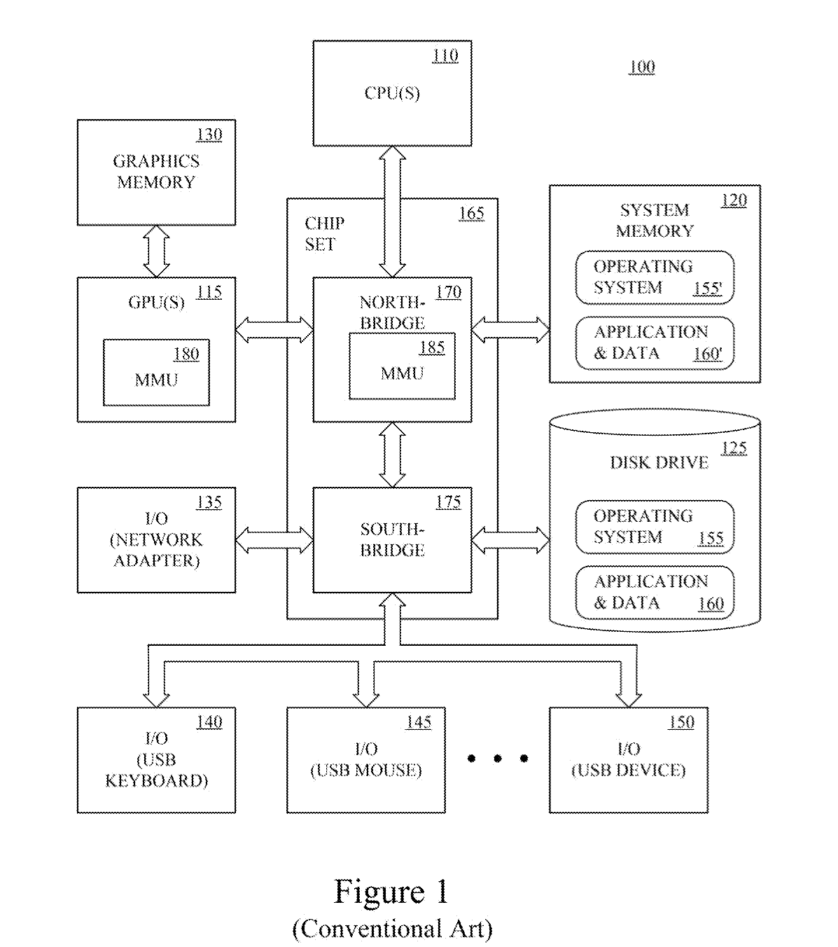

FIG. 2 shows a block diagram of an exemplary address translation data structure.

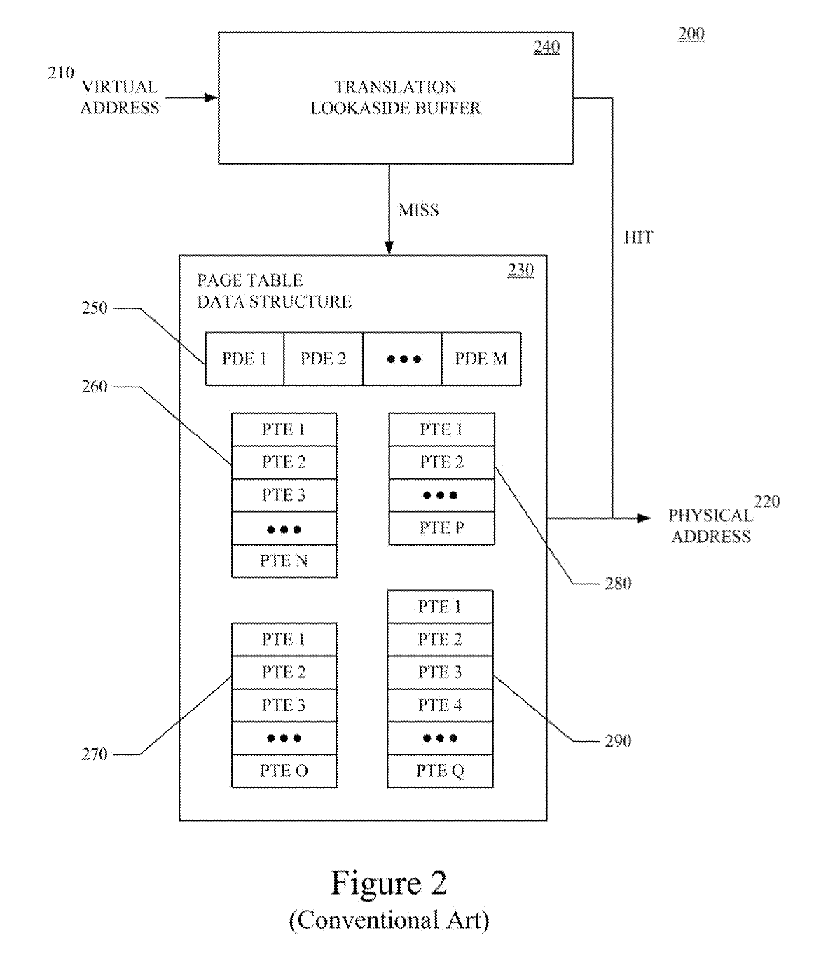

FIG. 3 shows a flow diagram of a unified virtual memory (UVM) management method, in accordance with one embodiment of the present technology.

FIG. 4 shows a block diagram of a memory mapping data structure, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a sell-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise or as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. It is also to be understood that the phraseology and terminology used herein is for the purpose of description and should not be regarded as limiting.

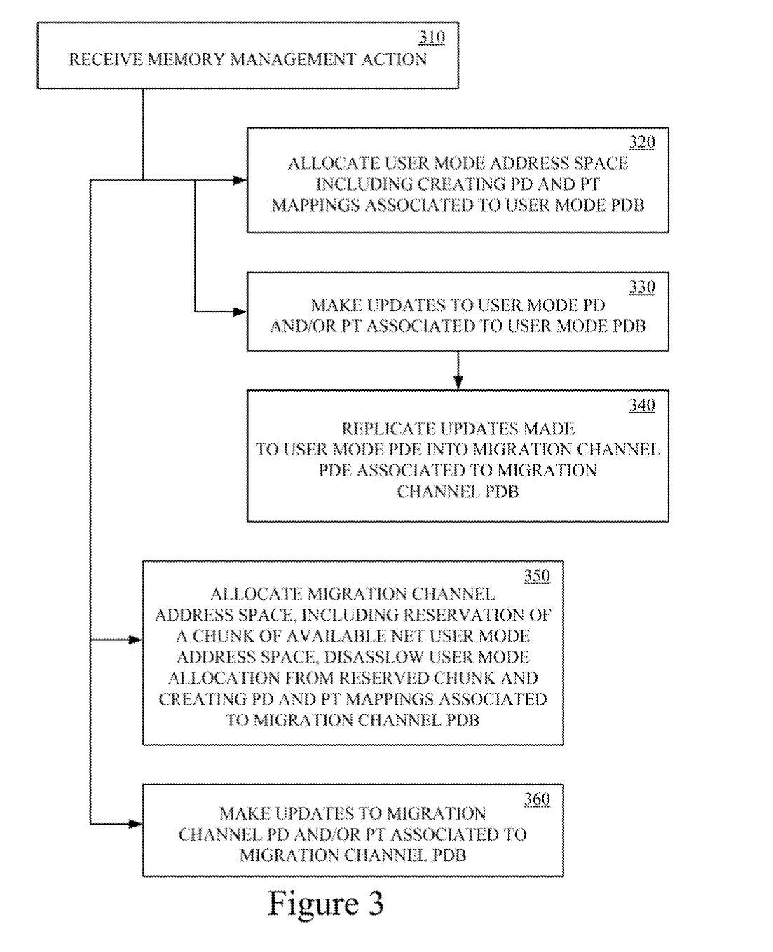

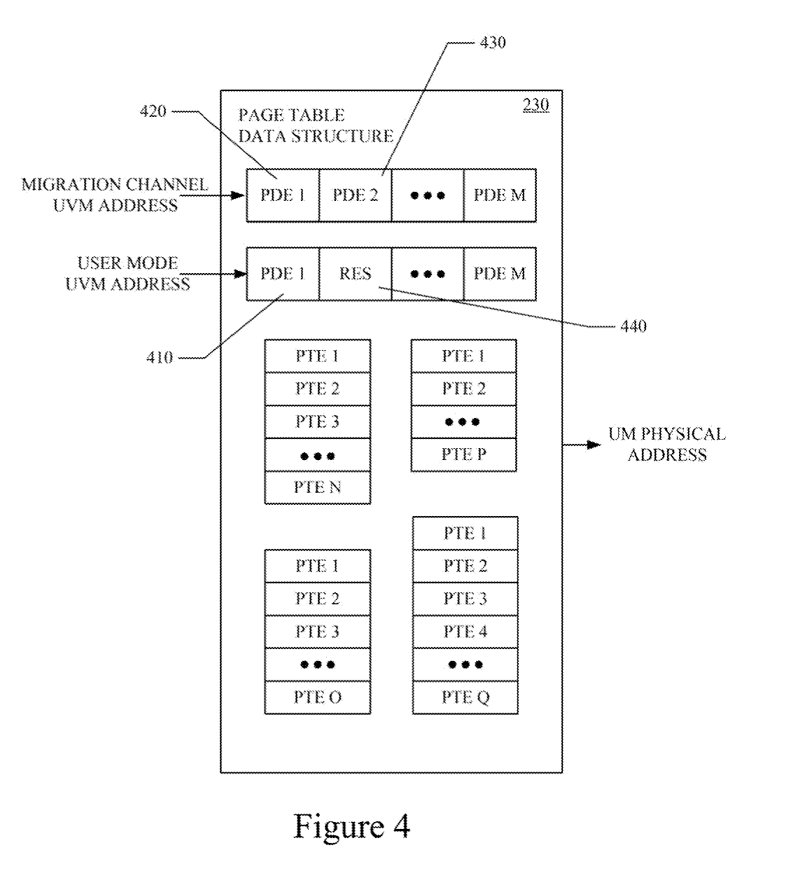

Referring now to FIG. 3, a unified virtual memory (UVM) management method, in accordance with one embodiment of the present technology, is shown. The UVM management method will be further explained with reference to an exemplary memory mapping data structure illustrated in FIG. 4. The method may be implemented as computing device-executable instructions (e.g., computer program) that are stored in computing device-readable media (e.g., computer memory) and executed by a computing device (e.g., processor).

At 310, a memory management action associated with a unified memory is received. The memory management action may be received by a unified memory kernel mode driver. The memory management action is associated with a channel for a particular GPU memory space. If the memory management action is associated with allocation of user mode address space, appropriate page director entries (PDE) and page director table (PTE) are mapped for a user mode page directory base (PDB), at 320. At 330, any user mode address space updates are made to the user mode PD and/or PT associated with the user mode PDB. For example, the PDE1 410 value may be updated in the PD for the user mode. If updates are made to the user mode PD, the PDE updates are also migrated to migrations channel PD at the migration channel page director base PDB, at 340. For example, if the PDE1 value in the PD for the user mode is updated, the PDE1 420 value is also migrated to the migration channel PD for the migration channel. In accordance with processes 320-340, both the user mode and migration channel share the same user page tables.

If the memory management action is associated with allocation of migration mode address space, a chunk of available net user mode address space is reserved such that user mode allocations from the reserved chunk are disallowed, and appropriate page director entries (PDE) and page director table (PTE) are mapped for migration mode page director base (PDB), at 350. The size of the chunk may be a multiple of the address range which a PDE spans. For example, a PDE2 430 value may be stored in the PD for the migration channel. In the PD of the user mode, a chunk is reserved 440 such that allocation is disallowed. At 360, any migration mode address space updates are made to the migration mode PD and/or PT. In accordance with processes 350-360, no mappings are created in the user mode PD in the corresponding reserved chunk (i.e., privileged range). Furthermore, if a user mode memory access request tries to access data in the reserved chunk 440, a fault by the GPU will occur.

Although embodiments of the present technology have been described with reference to a page table data structure include page directories and page tables (e.g., 2 level address translation), the present technology may be implemented for page table data structures have any number of levels of address translation. The embodiments were also described with reference to a CPU and its associated system memory along with a GPU and its associate system GPU memory. However, embodiments of the present invention may readily be extended to any combination of processors, wherein the term processor refers to any independent execution unit with a dedicated memory management unit. Embodiments of the present technology may also be readily extended to memory management between a host processor and any number of device processors (e.g., a plurality of GPUs). In such case, the migration channel of each particular device processor is associated with a particular page directory base of a respective page directory, while sharing page tables there between.

Embodiments of the present technology advantageously do not waste memory creating new page tables just to remap the user mode physical pages. Taking into account the fact that the GPU does not provide privilege levels of operation/access like a CPU does, embodiments also create the nation of privileged levels of data access for migration in a UVM system. Embodiments of the present technology share page tables between the user mode and kernel mode driver in a secure way. Accordingly only the kernel using privileged GPU copy engine channels has access to privileged data (e.g., migration data). Embodiments of the present technology also advantageously eliminate separate tracking/translation required in the kernel driver.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A method comprising:
allocating user mode address space, including creating page-directory and page table mappings associated to a user mode page directory base; and
allocating migration channel address space, including reserving a chunk of available user mode address space, disallowing user mode allocation from reserved chunk and creating page directory and page table mappings associated to a migration channel page directory base.

2. The method according to claim 1, further comprising:
making user mode page directory or page table updates associated to the user mode page director base; and
replicating the updates made to the user mode page directory into the migration channel page directory associated to the migration channel page directory base.

3. The method according to claim 1, further comprising making migration channel page directory or page table updates associated to the migration channel page directory base.

4. The method according to claim 1, wherein the size of the chunk is a multiple of an address range spanned by a page directory entry.
